(19) United States
(12) Patent Application Publication
(10) Pub. No.: US 2026/0015780 A1
(43) Pub. Date: Jan. 15, 2026

(54) PROCESS FOR PREPARING POROUS METAL FIBRE MATS

(71) Applicant: IMPERIAL COLLEGE INNOVATIONS LIMITED, London (GB)

(72) Inventors: Mengzheng OUYANG, London (GB); Nigel Peter BRANDON, London (GB)

(21) Appl. No.: 18/996,484

(22) PCT Filed: Jul. 25, 2023
(86) PCT No.: PCT/EP2023/070626

§ 371 Date: Jan. 17, 2025

(30) Foreign Application Priority Data
Jul. 25, 2022 (GB) 2210835.1

(51) Int. Cl. D04H 1/728; D04H 1/4234

(52) U.S. Cl. CPC D04H 1/728; D04H 1/4234; D10B 2101/20

(57) ABSTRACT

The present invention relates to a process for preparing a porous metal fibre mat comprising providing a slurry comprising particles selected from metal particles, metal compound particles, or combinations thereof, and a polymer carrier in a solvent, electrospinning the slurry to fabricate a composite fibre mat, and heating the composite fibre mat to produce the porous metal fibre mat. The present invention also relates to a porous metal fibre mat having a specific surface area of at least 500 cm⁻¹ and a thickness of at least 0.05 mm, and uses of the same as an electrode, a catalyst, a catalyst support, or a filtration material.

### FIELD OF THE INVENTION

This invention relates to porous metal materials that are may be useful in the fields of electrochemistry and catalysis.

### BACKGROUND TO THE INVENTION

Porous metal materials are a particularly useful class of materials in the fields of catalysis and energy. An example of such materials is metal foam. However, conventional processes for producing metal foam yield materials with a low specific surface area (<500 cm⁻¹). Such metal foams have limited utility in fields such as catalysis, lithium ion batteries, supercapacitors, in which the performance of materials is proportional to their specific surface area. US 2021/344017 A and CN107552797 A each disclose metal foams prepared by freeze-casting.

Thus, there is a need to develop porous metal materials that possess high specific surface areas but that remain mechanically strong. The present invention addresses this need using a process based on electrospinning.

### SUMMARY OF THE INVENTION

In a first aspect, provided herein is a process for preparing a porous metal fibre mat comprising:
a. providing a slurry comprising particles selected from metal particles, particles of metal compound, or combinations thereof, and a polymer carrier in a solvent;
b. electrospinning the slurry to fabricate a composite fibre mat; and
c. heating the composite fibre mat to produce a porous metal fibre mat.

In a second aspect, provided herein is a porous metal fibre mat obtainable by the process according to the first aspect.

In a third aspect, provided herein is a porous metal fibre mat wherein the metal fibre mat has:
a specific surface area of at least 500 cm⁻¹; and
a thickness of at least 0.05 mm.

In a fourth aspect, provided herein is the use of a porous metal fibre mat according to the second or third aspect as an electrode.

In a fifth aspect, provided herein is the use of a porous metal fibre mat according to the second or third aspect as a catalyst or a catalyst support.

In a sixth aspect, provided herein is the use of a porous metal fibre mat according to the second or third aspect as a filtration material.

### BRIEF DESCRIPTION OF FIGURES

FIG. 1 compares SEM images of a nickel foam (Ni-5763, obtained from Recemat BV) and a nickel fibre mat according to the invention.

FIG. 2 shows the tensile strength test results obtained in example 7 for a nickel fibre mat according to the invention, and a nickel foam.

FIG. 3 shows the compression test results obtained in example 7 for a nickel fibre mat according to the invention, and a nickel foam.

FIG. 4 shows the electrochemical properties observed in example 8 when a nickel fibre mat according to the invention and a nickel foam were each used as the electrochemical catalyst of a polysulfide oxidation/reduction reaction.

FIG. 5 shows the electrochemical properties observed when the nickel fibre mat according to the invention was used as the cathode of a lithium ion battery.

FIG. 6 shows the electrochemical properties observed when the nickel fibre mat according to the invention was used as both electrodes of an alkaline water electrolyser.

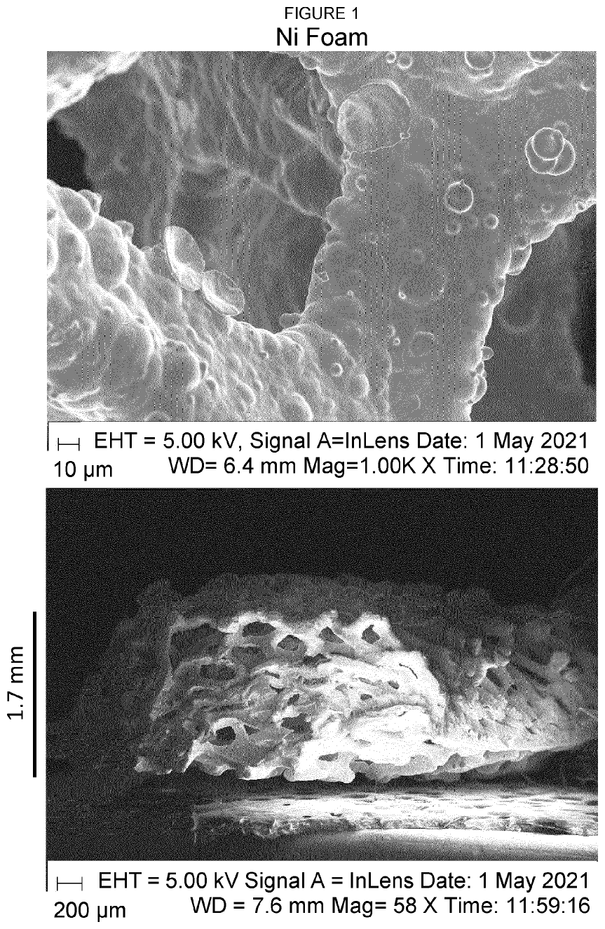

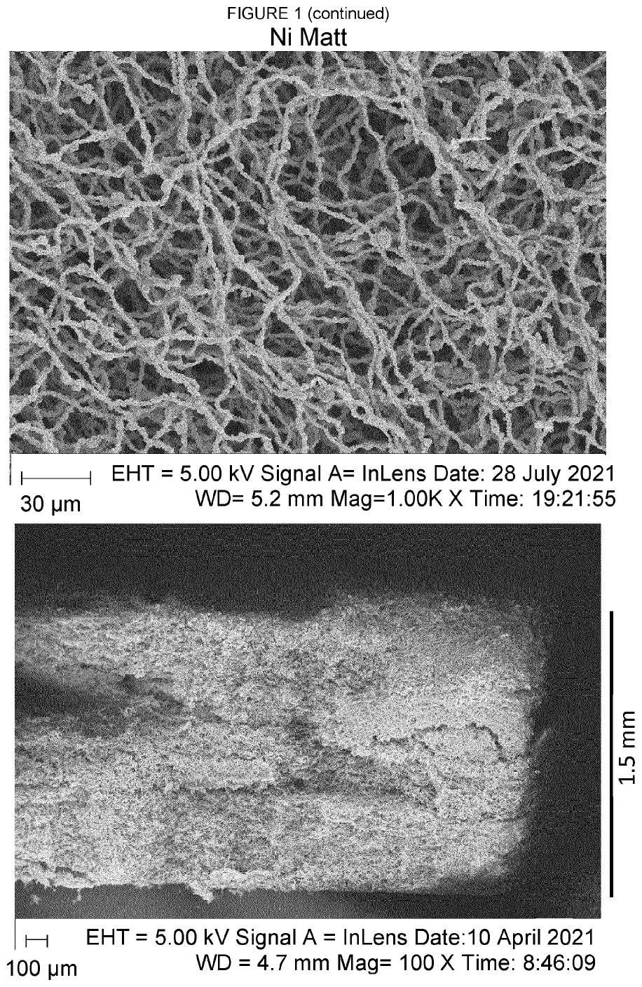

### DETAILED DESCRIPTION

### Process for Preparing a Porous Metal Fibre Mat

In a first aspect, provided herein is a process for preparing a porous metal fibre mat comprising:
a. providing a slurry comprising particles selected from metal particles, particles of a metal compound, or combinations thereof, and a polymer carrier in a solvent;
b. electrospinning the slurry to fabricate a composite fibre mat; and
c. heating the composite mat to produce a porous metal fibre mat.

The porous metal fibre mat obtainable from this process contains a plurality of metal fibres. The metal fibres have a high aspect ratio such that their length is at least one order of magnitude greater than their diameter. The process according to the first aspect yields a porous metal fibre mat wherein the plurality of metal fibres are arranged to provide a material that is porous and has a high specific surface area.

The first step of the process (step a) involves providing a slurry comprising particles selected from metal particles, metal compound particles, or combinations thereof, and a polymer carrier in a solvent.

The particles in the slurry are selected from metal particles, particles of a metal compound, or combinations thereof. Metal particles are particles comprising metal atoms in their zero-valent state.

The metal particles may be nickel particles, copper particles, iron particles, aluminium particles, titanium particles, zinc particles, or a mixture thereof. Preferably, the metal particles may be zinc particles, aluminium particles, or mixtures thereof.

Particles of a metal compound are particles comprising compounds that contain metal cations. The particles of a metal compound may be metal oxide particles, metal sulfide particles, metal carbide particles, metal nitride particles, metal phosphide particles, metal carbonate particles or combinations thereof. The metal compounds particles may be nickel compound particles, copper compound particles, iron compound particles, aluminium compound particles, titanium compound particles, zinc compound particles, or a mixture thereof.

Preferably, the metal compounds particles may be nickel compound particles, copper compound particles, iron compound particles, zinc compound particles, or a mixture thereof. More preferably, the metal compounds particles may be nickel compound particles, copper compound particles, or a mixture thereof.

The particles of a metal compound may be metal oxide particles. Metal oxide particles are particles comprising compounds that contain metal cations and oxygen anions. The metal oxide particles may be nickel oxide particles, copper oxide particles, iron oxide particles, aluminium oxide particles, titanium oxide particles, zinc oxide particles, or a mixture thereof.

Preferably, the metal oxide particles may be nickel oxide particles, copper oxide particles, iron oxide particles, zinc oxide particles, or a mixture thereof. More preferably, the metal oxide particles may be nickel oxide particles, copper oxide particles, or a mixture thereof.

The slurry may comprise a sintering aid. If present, the sintering aid may preferably be present in amounts of from about 1 wt. % to about 15 wt. % based on the amount of metal particles, metal compound particles, or combinations thereof.

If the metal particles are aluminium particles, the sintering aid may preferably be selected from copper, tin, zinc, magnesium, KAlF₄, AlCl₃, NH₄Cl, LiCl, or a mixture thereof. Preferably, the sintering aid is magnesium and/or KAlF₄. More preferably, the sintering aid is magnesium or a mixture of magnesium and KAlF₄.

If the metal particles are titanium particles, the sintering aid may preferably be iron, magnesium, copper, zinc, nickel, silicon, or a mixture thereof.

The particles may have an average size of from 0.01 μm to 2 μm. The particles may have an average size of from 0.1 μm to 2 μm, for example from 0.2 μm to 0.8 μm. The particles may therefore have an average size of about 0.5 μm. In this context, average size is the numerical mean diameter of the particles. In this context, the diameter of a particle is the longest straight-line distance between two edges of the particle. The average particle size can be determined by obtaining microscopy images (for example, scanning electron microscopy (SEM) images) of a sample of the particles and measuring the size of the particles in the microscopy images and calculating the average. For example, the average particle size can be determined by obtaining SEM images of three different viewing locations of the sample, measuring the size of 20 randomly chosen particles in each of the SEM images, and then calculating the average particle size.

The particle loading in the slurry, that is the concentration of metal and/or metal oxide particles in the slurry, may range from 0.2 g mL⁻¹ to 0.9 g mL⁻¹. For example, the particle loading in the slurry may be about 0.5 g mL⁻¹.

The polymer carrier is provided in the slurry to make it electro-spinnable. The polymer carrier may, therefore be any polymer that is electro-spinnable. The polymer carrier may therefore be a polyacrylonitrile (PAN), a polyethylene oxide (PEO), a polyvinylpyrrolidone (PVP), a polyvinyl alcohol (PVA), a polyamide (Nylon), a polymethylmethacrylate (PMMA), a polyvinyl ether (PVE), a polyethylene terephthalate (PET), a polyvinylidene fluoride (PVDF), a polyvinyl chloride (PVC), a chitosan, a lignin, a cellulose, or a polylactic acid (PLA). For example, the polymer carrier may be a polyacrylonitrile (PAN), a polyethylene oxide (PEO), a polyvinylpyrrolidone (PVP), a polyvinyl alcohol (PVA), a polyamide (Nylon), a polymethylmethacrylate (PMMA), or a polyvinyl ether (PVE).

The weight average molecular weight of the polymer carrier may range from 10k to 1500k g mol⁻¹. For example, the weight average molecular weight of the polymer carrier may range from 15k to 1300k g mol⁻¹. The weight average molecular weight of the polymer carrier may vary depending on the type of polymer used. For example, the polymer carrier may be PAN with a weight average molecular weight of from 50k to 400k g mol⁻¹, such as 200k to 260k g mol⁻¹ (for example, about 230k g mol⁻¹). The polymer carrier may be PEO with a weight average molecular weight of from 15k to 500k g mol⁻¹, such as 15k to 60k g mol⁻¹ (for example, about 30k g mol⁻¹), or PEO with a weight average molecular weight of from 30k to 90k g mol⁻¹ (for example, about 60k g mol⁻¹), or PEO with a weight average molecular weight of 70k to 130k g mol⁻¹ (for example, about 100k g mol⁻¹). The polymer carrier may be PVP with a weight average molecular weight of from 50k to 1300k g mol⁻¹.

The amount of polymer carrier provided in the slurry may vary depending on the type of polymer and its weight average molecular weight. For example, when the polymer carrier is PAN with a molecular weight of from 200k to 260k g mol⁻¹ (for example, about 230k g mol⁻¹), it may be provided in the slurry in an amount of from 0.05 to 0.15 g mL⁻¹. Alternatively, when the polymer carrier is PEO with a molecular weight of from 15k to 60k g mol⁻¹ (for example, about 30k g mol⁻¹), it may be provided in the slurry in an amount of from 0.08 to 0.20 g mL⁻¹. Alternatively, when the polymer carrier is PEO with a molecular weight of from 30k to 90k g mol⁻¹ (for example, about 60k g mol⁻¹), it may be provided in the slurry in an amount of from 0.04 to 0.15 g mL⁻¹. Alternatively, when the polymer carrier is PEO with a molecular weight of from 70k to 130k g mol⁻¹ (for example, 100k g mol⁻¹), it may be provided in the slurry in an amount of from 0.02 to 0.08 g mL⁻¹.

The solvent in the slurry can be any solvent that is usable in electrospinning. For example, the solvent may be water, dimethylformamide (DMF), ethanol, acetone, acetic acid, formic acid, chloroform, dichloromethane (DCM), dimethyl sulfoxide (DMSO), dimethylacetamide (DMA), toluene, oxolane or a mixture thereof. For example, the solvent may be water or DMF.

The slurry provided in the first step (step a) may be prepared by mixing the particles, polymer carrier and solvent together at an elevated temperature, provided said temperature is below the boiling point of the solvent and is not a temperature that will cause decomposition of the polymer carrier. In this context, elevated temperature is any temperature above room temperature (which, in this application, is considered to a temperature ranging from 18° C. to 25° C.). For example, the slurry may be prepared by mixing the solvent, polymer carrier and the particles at a temperature of at least 50° C. For example, the slurry may be prepared by mixing the solvent, polymer carrier and the particles at a temperature of from 50° C. to 80° C.

The slurry may further comprise a surfactant. The surfactant may be incorporated into the slurry by mixing it with the solvent, polymer carrier and particles at an elevated temperature as described in the previous paragraph. The surfactant may be any surfactant that improves the miscibility of components of the slurry. For example, the surfactant may be Triton X-100 (2-[4-(2,4,4-trimethylpentan-2-yl) phenoxy]ethanol), oleic acid, CTAB (cetyltrimethyl ammonium bromide), (CMC) carboxymethyl cellulose, or combinations thereof. The surfactant may be provided in the slurry at a concentration of 0.001 g mL⁻¹ to 0.05 g mL⁻¹.

The weight ratio of particles to polymer carrier in the slurry can vary provided that the slurry remains electro-spinnable. The weight ratio of particles to polymer carrier in the slurry may be at least 1:1. For example, the weight ratio of particles to polymer carrier in the slurry may be from 1:1 to 50:1, from 1.5:1 to 15:1, or from 15:1 to 9:1.

The second step of the process (step b) involves electrospinning the slurry to fabricate a composite fibre mat. A composite fibre mat is made of composite fibres of the electrospun slurry. Electrospinning is a well-known method of producing fibres where charged polymer solutions are drawn through an electric field, with the resultant fibres being collected in a collection plate.

The electrospinning may be carried out with the slurry at room temperature or at an elevated temperature (both of which have been defined above). For example, the electrospinning may be carried out with the slurry at a temperature of from 18° C. to 80° C.

The electrospinning voltage, the voltage of the electric field applied during the electrospinning, can vary to affect the physical properties of the composite fibres that are produced. For example, the electrospinning may be carried out at a voltage of from 5 to 25 kV.

The electrospinning rate, the rate at which the slurry is passed through the electric field, can vary to affect the physical properties of the composite fibres that are produced. For example, the electrospinning may be carried out at a rate of from 0.1 mL h⁻¹ to 10 mL h⁻¹.

The slurry may be drawn through an electrospinning nozzle to spin the composite fibres or the fibres may be spun without using a nozzle (i.e. in a nozzleless electrospinning process). When an electrospinning nozzle is used, one electrospinning nozzle may be used or more than one electrospinning nozzle may be used. The diameter of the electrospinning nozzle used in the electrospinning process can vary to affect the physical properties of the composite fibres that are produced. For example, the electrospinning may be carried out using an electrospinning nozzle with a diameter of from 15 gauge to 25 gauge (0.51 mm to 18.3 mm).

The distance between the electrospinning nozzle and the collection place can vary to affect the physical properties of the composite fibres that are produced. For example, the electrospinning may be carried out using a collection plate positioned from 2 cm to 30 cm away from the electrospinning nozzle.

Relative humidity of the environment can affect the properties the composite fibres that are produced during electrospinning. Relative humidity is the ratio of the partial pressure of water vapor in the air to the equilibrium vapor pressure of water. The electrospinning may be carried out at relative humidity of not greater than 80%.

The third step of the process (step c; the heating step) involves heating the composite fibre mat to produce the porous metal fibre mat. This may be referred to as calcining. This heating step removes the polymer carrier and sinters the particles in the composite fibre mat. The composite fibre mat may be heated to a temperature of from 200° C. to 2000° C. during the heating step. For example, the composite fibre mat may be heated at a temperature of from 400° C. to 1200° C.

The rate at which temperature is increased during the heating step may be controlled. For example, the temperature may be increased at a rate of from 0.2° C. min⁻¹ to 2° C. min⁻¹ during the heating step. Once the composite fibre mat has been heated to the desired temperature, it is kept at that temperature for enough time remove polymer carrier from the composite fibre mat. For example, the composite mat may be heated at the desired temperature for at least 2 hours (e.g. for about 5 hours).

The heating step may be conducted in air or may be conducted in an inert atmosphere, for example, a nitrogen atmosphere.

When particles of a metal compound (for example, metal oxide particles) are present in the composite fibre mat, the heating step reduces those particles in the composite fibre mat to produce a porous metal fibre mat. In this case, the heating step includes subjecting the composite fibre mat to conditions that will reduce particles of a metal compound in the composite mat. For example, the composite fibre mat may be contacted with H₂ during the heating step. The H₂ may be provided as part of a gas mixture, such as a gas comprising H₂ and N₂. The H₂ may be provided as a part of a gas that comprises at least 5 vol % H₂. Therefore, the H₂ may be provided as 5 vol % H₂/N₂ (this is, 5 vol % H₂ in N₂).

One option is to conduct the heating step in two stages: with a first stage where the polymer carrier in the composite fibre mat is removed and the particles are sintered as described above, followed by a second stage, where particles of a metal compound are reduced. These stages may be carried out in the same apparatus (for example, a furnace).

The second stage may include heating to a temperature of from 200° C. to 2000° C. (for example, to a temperature of from 400° C. to 1200° C.). The rate at which the temperature is increased during this stage may be controlled. For example, the temperature may be increased at a rate of from 0.2° C. min⁻¹ to 2° C. min⁻¹ during the second stage. Once the desired temperature is reached, that temperature is maintained for enough time to reduce the metal compounds and yield a porous metal fibre mat. For example, the composite fibre mat may be heated at the desired temperature for at least 2 hours (e.g for about 5 hours). The second stage may be carried out in the presence of H₂. The H₂ may be provided as part of a gas mixture, such as a gas comprising H₂ and N₂. The H₂ may be provided as a part of a gas that comprises at least 5 vol % H₂. Therefore, the H₂ may be provided as 5 vol % H₂/N₂ (this is, 5 vol % H₂ in N₂).

The process can be used to prepare a porous metal fibre mat with increased thickness by, prior to the third step, folding the composite fibre mat onto itself. Alternatively, multiple composite fibre mats prepared in accordance with the process (i.e. prepared according to the first and second steps) are laid on top of each other prior to the heating step. The folded/overlaid composite fibre mat may be subjected to a pre-heating step where, prior to the heating step, it is heated to sinter together the folded/overlaid parts of the mat. For example, the pre-heating step may involve heating the folded/overlaid composite fibre mat to a temperature of from 120° C. to 400° C. (for example, about 250° C.) for a period of time (for example about 2 hours) prior to the heating step. The rate at which temperature is increased during the pre-heating step may be controlled. For example, the temperature may be increased at a rate of from 0.2° C. min⁻¹ to 2° C. min⁻¹ during the pre-heating step.

### Porous Metal Fibre Mats

In a second aspect, provided herein is a porous metal fibre mat obtainable by the process according to the first aspect.

In a third aspect, provided herein is a porous metal fibre mat wherein the metal fibre mat has:
a specific surface area of at least 500 cm⁻¹; and
a thickness of at least 0.05 mm.

The porous metal fibre mat contains a plurality of metal fibres. The metal fibres have a high aspect ratio such that their length is many orders of magnitude greater than their diameter. The porous metal fibre mat is formed from a plurality of metal fibres arranged to provide a material that is porous and has a high specific surface area.

The metal fibres in the porous metal fibre mat may be nickel fibres, copper fibres, iron fibres, aluminium fibres, titanium fibres, or zinc fibres. The porous metal fibre mat may have a thickness that ranges from 0.05 mm to 10 mm.

The porous metal fibre may have a porosity of at least 50 vol %, for example at least 70 vol % or at least 80 vol %. In this context, porosity is a measure of the portion of the mat that is void space (i.e. the space not taken up by the fibres in the mat). The porous metal fibre mat may, therefore, have a porosity of from 80 vol % to 98 vol %, for example, from 80 vol % to 90 vol %. The porosity of the porous metal fibre mat can be measured by simple analysis of the weight and volume of the mat, or by Brunauer-Emmett-Teller (BET) analysis. The porosity can also be determined using Tau-Factor software according to the methods described in S. J. Cooper, et al, SoftwareX, 2016, 5, 203-210 (https://doi.org/10.1016/j.softx.2016.09.002).

The porous metal fibre mat has a specific surface area, the total area surface area of the mat per unit mass, is at least 500 cm⁻¹. The porous metal fibre mat may, therefore, have a specific surface area of from 500 cm⁻¹ to 50000 cm⁻¹. The specific surface area of the porous metal fibre mat can be determined by Brunauer-Emmett-Teller (BET) analysis. The specific surface area can also be determined using Tau-Factor software according to the methods described in S. J. Cooper, et al, SoftwareX, 2016, 5, 203-210 (https://doi.org/10.1016/j.softx.2016.09.002).

The porous metal fibre mat, contains a plurality of pores that allow access to the internal surfaces of the mat. The porous metal fibre mat may have pores with an average size that ranges from 0.5 μm to 5.0 μm, for example, the average pore size may be about 2.5 μm. In this context, average pore size is the numerical mean size of the pores in the porous metal fibre mat, where “pore size” is the furthest straight-line distance between two edges of a pore. Average pore size can be determined by measuring the size of pores in the porous metal fibre mat visible in microscopy images, such as scanning electron microscopy (SEM) images.

The porous metal fibre mat has a thickness of at least 0.05 mm. The porous metal fibre mat may, therefore, have a thickness ranging from 0.05 mm to 10 mm. In this context, thickness defines the smallest of the three spatial dimensions of mat (i.e. the other two spatial dimensions of the mat, the length and width, are larger than the thickness).

The porous metal fibre mat of the third aspect may be obtainable by the process according to the first aspect.

In a fourth aspect, provided herein is the use of a porous metal fibre mat according to the second or third aspect as an electrode. For example, the porous metal fibre mat may be used as an electrode in a battery, such as a lithium-sulfur battery or a redox flow battery. The porous metal fibre mat may also be used as an electrode in a supercapacitor, or as an electrode in a fuel cell.

In a fifth aspect, provided herein is the use of a porous metal fibre mat according to the second or third aspect as a catalyst or a catalyst support. When the porous metal fibre mat is being used as a catalyst, it is providing a large active surface area which can be used to catalyse a reaction taking place in a liquid or a gaseous phase (i.e. the mat is serving as a heterogenous catalyst). The high porosity of the porous metal fibre mats allows reagents to access the large active surface area. When the porous metal fibre mat is being used as catalyst support, it is providing a large surface area that is impregnated/doped with a catalyst. The high porosity of the porous metal fibre mats allows reagents to access the impregnated/doped surface.

In a sixth aspect, provided herein is the use of a porous metal fibre mat according to the second or third aspect as a filtration material. When the porous metal fibre mater is being used as a filtration material, a mixture of matter is passed through the mat, with some elements of the mixture being prevented from passing through the mat, thus separating the mixture.

All publications, published patent documents, and patent applications cited herein are hereby incorporated by reference to the same extent as though each individual publication, published patent document, or patent application was specifically and individually indicated as being incorporated by reference.

As used herein, singular forms “a,” “an” and “the” also include plural forms unless the context clearly dictates otherwise. Use of the singular includes the plural unless specifically stated otherwise. The terms “comprising”, “containing”, “including” and “having” as well as other forms (e.g., “include,” “comprise”, “contain” and “has”) do not exclude the presence of other features. As used herein, wherever “comprising” is referenced, this may also be interpreted to mean “consisting essentially of” and “consisting of”. For example, a slurry comprising particles selected from metal particles, metal oxide particles, or combinations thereof, and a polymer carrier in a solvent, may also be considered to disclose a slurry consisting essentially of said components and a slurry consisting of said components.

Where concentration units are expressed in terms of their units, they may also be expressed as a ratio. For example, a slurry with a particle loading that ranges from 0.2 g mL⁻¹ to 0.9 g mL⁻¹ can also be expressed as a range of from 20 w/v % to 90 w/v %.

The aspects provided herein are also described in the following clauses:
1. A process for preparing a porous metal fibre mat comprising:
   a. providing a slurry comprising particles selected from metal particles, metal oxide particles, or combinations thereof, and a polymer carrier in a solvent;
   b. electrospinning the slurry to fabricate a composite fibre mat; and
   c. heating the composite fibre mat to produce a porous metal fibre mat.
2. The process according to clause 1, wherein the particles are metal particles.
3. The process according to clause 1, wherein the particles are metal oxide particles.
3a. The process according to any preceding clause, wherein the slurry comprises a sintering aid.
3b. The process according to clause 3a, wherein the sintering aid is present in amounts of from about 1 wt. % to about 15 wt. % based on the amount of metal particles, metal compound particles, or combinations thereof.
3c. The process according to clause 3a or 3b, wherein the particles are aluminium particles, and the sintering aid is selected from copper, tin, zinc, magnesium, KAlF₄, AlCl₃, NH₄Cl, LiCl, or a mixture thereof.
3d. The process according to clause 3c, wherein the sintering aid is magnesium, or magnesium and KAlF₄.
3e. The process according to clause 3a or 3b, wherein the particles are titanium particles, and the sintering aid is selected from iron, magnesium, copper, zinc, nickel, silicon, or a mixture thereof.
4. The process according to clause 1, wherein the particles are metal particles selected from nickel particles, copper particles, iron particles, aluminium particles, titanium particles, zinc particles, or a mixture thereof.
4a. The process according to clause 4, wherein the metal particles are selected from aluminium particles, zinc particles, or a mixture thereof.
5. The process according to clause 1, wherein the particles are metal oxide particles selected from nickel oxide particles, copper oxide particles, iron oxide particles, aluminium oxide particles, titanium oxide particles, zinc oxide particles, or a mixture thereof.
5a. The process according to clause 5, wherein the metal oxide particles are selected from nickel oxide particles, copper oxide particles, iron oxide particles, zinc oxide particles, or a mixture thereof.
5b. The process according to clause 5a wherein the metal oxide particles are selected from nickel oxide particles, copper oxide particles, or a mixture thereof.
5c. The process according to clause 1, wherein the particles are selected from zinc particles, aluminium particles, nickel oxide particles, copper oxide particles, or mixtures thereof.
6. The process according to any preceding clause, wherein the particles have an average size of from 0.01 μm to 2 μm, for example from 0.1 μm to 2 μm, for example from 0.2 μm to 0.8 μm.
7. The process according to any preceding clause, wherein the particle loading in the slurry ranges from 0.2 g mL⁻¹ to 0.9 g mL⁻¹.
8. The process according to any preceding clause, wherein the polymer carrier is a polyacrylonitrile (PAN), a polyethylene oxide (PEO), a polyvinylpyrrolidone (PVP), a polyvinyl alcohol (PVA), a polyamide (Nylon), a polymethylmethacrylate (PMMA), a polyvinyl ether (PVE), a polyethylene terephthalate (PET), a polyvinylidene fluoride (PVDF), a polyvinyl chloride (PVC), a chitosan, a lignin, a cellulose, or a polylactic acid (PLA).
9. The process according to any preceding clause, wherein the polymer carrier is a polyacrylonitrile (PAN), a polyethylene oxide (PEO), a polyvinylpyrrolidone (PVP), a polyvinyl alcohol (PVA), a polyamide (Nylon), a polymethylmethacrylate (PMMA), or a polyvinyl ether (PVE)
10. The process according to any preceding clause, wherein the polymer carrier has a weight average molecular weight of from 10k to 1500k g mol⁻¹.
11. The process according to any preceding clause, wherein the polymer carrier is selected from:
   PAN with a weight average molecular weight of from 50k to 400k g mol⁻¹;
   PEO with a weight average molecular weight of from 15k to 500k g mol⁻¹; or
   PVP with a weight average molecular weight of from 50k to 1300k g mol⁻¹.
12. The process according to any preceding clause, wherein the polymer carrier is selected from:
   PAN with a weight average molecular weight of from 50k to 400k g mol⁻¹, such as 200k to 260k g mol⁻¹ (for example, about 230k g mol⁻¹);
   PEO with a weight average molecular weight of from 15k to 500k g mol⁻¹, such as 15k to 60k g mol⁻¹ (for example, about 30k g mol⁻¹) or PEO with a weight average molecular weight of from 30k to 90k g mol⁻¹ (for example, about 60k g mol⁻¹); or PEO with a weight average molecular weight of 70k to 130k g mol⁻¹ (for example, about 100k g mol⁻¹); or
   PVP with a weight average molecular weight of from 50k to 1300k g mol⁻¹.
13. The process according to any preceding clause, wherein the polymer carrier is selected from:
   PAN with a molecular weight of from 200k to 260k g mol⁻¹ provided in the slurry in an amount of from 0.05 to 0.15 g mL⁻¹, optionally wherein the PAN has a molecular weight of about 230k g mol⁻¹;
   PEO with a molecular weight of from 15k to 60k g mol⁻¹ provided in the slurry in an amount of from 0.08 to 0.20 g mL⁻¹, optionally wherein the PEO has a molecular weight of about 30k g mol⁻¹;
   PEO with a molecular weight of from 30k to 90k g mol⁻¹ provided in the slurry in an amount of from 0.04 to 0.15 g mL⁻¹, optionally wherein the PEO has a molecular weight of about 60k g mol⁻¹; or
   PEO with a molecular weight of from 70k to 130k g mol⁻¹ provided in the slurry in an amount of from 0.02 to 0.08 g mL⁻¹, optionally wherein the PEO has a molecular weight of about 100k g mol⁻¹.
14. The process according to any preceding clause, wherein the solvent is selected from water, dimethylformamide (DMF), ethanol, acetone, acetic acid, formic acid, chloroform, dichloromethane (DCM), dimethyl sulfoxide (DMSO), dimethylacetamide (DMA), toluene, oxolane, or a mixture thereof.
15. The process according to any preceding clause, wherein the solvent is selected from water or dimethylformamide (DMF).
16. The process according to any preceding clause, wherein the slurry is prepared by mixing the solvent, polymer carrier, and particles at a temperature of at least 50° C.
17. The process according to claim any preceding clause, wherein the slurry is prepared by mixing the solvent, polymer carrier, and particles at a temperature of from 50° C. to 80° C.
18. The process according to any preceding clause, wherein the slurry further comprises a surfactant, optionally wherein the surfactant is present at a concentration ranging from 0.001 g mL⁻¹ to 0.05 g mL⁻¹.
19. The process according to clause 18, wherein the surfactant is selected from Triton X-100, oleic acid, cetyltrimethyl ammonium bromide, carboxymethyl cellulose, or combinations thereof.
20. The process according to any preceding clause, wherein the weight ratio of particles to polymer carrier in the slurry is from at least 1:1, preferably from 1:1 to 50:1, more preferably from 1.5:1 to 15:1, even more preferably from 1.5:1 to 9:1.
21. The process according to any preceding clause, wherein the electrospinning is carried out with the slurry at a temperature of from 18° C. to 80° C.
22. The process according to any preceding clause, wherein the electrospinning is carried out at a voltage of from 5 to 25 kV.
23. The process according to any preceding clause, wherein the electrospinning is carried out at a rate of from 0.1 mL h⁻¹ to 10 mL h⁻¹.
24. The process according to any preceding clause, wherein the electrospinning is carried out using an electrospinning nozzle with a diameter of 15 to 25 gauge (0.51 mm to 1.83 mm).
25. The process according to any preceding clause, wherein the electrospinning is carried out using a collection plate positioned from 2 cm to 30 cm away from the electrospinning nozzle.
26. The process according to any preceding clause, wherein the electrospinning is carried out using more than one electrospinning nozzle.
27. The process according to any preceding clause, wherein the electrospinning is carried out at a relative humidity of not greater than 80%.
28. The process according to any preceding clause, wherein the composite fibre mat is heated to a temperature of from 200° C. to 2000° C. during the heating step, for example from 400° C. to 1200° C.
29. The process according to any preceding clause, wherein the temperature is increased at a rate of from 0.2° C. min⁻¹ to 2° C. min⁻¹ during the heating step.
30. The process according to any preceding clause, wherein the heating step is carried out in a furnace.
31. The process according to any preceding clause, wherein the heating step is carried out in air
32. The process according to any preceding clause, wherein the composite fibre mat is contacted with a H₂ gas during the heating step.
33. The process according to any preceding clause, wherein the composite mat is contacted with a gas that comprises at least 5 vol % H₂ during the heating step.
34. The process according to any preceding clause, wherein the composite mate is contacted with a gas that comprises H₂ and N₂, for example, 5 vol % H₂/N₂
35. The process according to any preceding clause, wherein the heating step in conducted in two stages, optionally wherein both stages are carried out in the same apparatus (for example, a furnace).
36. The process according to clause 35, wherein the first stage removes the polymer carrier in the composite fibre mat and sinters the particles, and the second stage reduces any metal compound particles to yield the porous metal fibre mat.
37. The process according to clause 36, wherein the first stage is carried out under conditions according to any of clauses 28 to 34.
38. The process according to clause 36 or clause 37, wherein the second stage is carried out under conditions according to any of clauses 28 to 34.
39. The process according to any preceding clause, wherein prior to the heating step, the composite mat is either folded onto itself or multiple composite fibre mats prepared in accordance with the process are laid on top of each.
40. The process according to clause 39, wherein the folded or overlaid composite fibre mat is subjected to a pre-heating step prior to the heating and reducing steps.
41. The process according to clause 40, wherein the pre-heating step is carried out at a temperature of from 120° C. to 400° C., for example about 250° C., optionally wherein the temperature is increased at a rate of from 0.2° C. min⁻¹ to 2° C. min⁻¹ during the pre-heating step.
42. A porous metal fibre mat obtainable by the process according to any preceding clause.
43. A composite fibre mat obtainable by the process according to steps a. and b. of any preceding clause.
44. A porous metal fibre mat, having:
   a specific surface area of at least 500 cm⁻¹; and
   a thickness of at least 0.05 mm.
45. The porous metal fibre mat according to clause 44, wherein the porous metal fibre mat has a porosity of at least 50 vol %, for example at least 70 vol %, or at least 80%; optionally from 80 vol % to 98 vol %, for example from 80 vol % to 90 vol %.
46. The porous metal fibre mat according to clause 44 or clause 45, wherein the porous metal fibre mat has a specific surface area of from 500 cm⁻¹ to 50000 cm⁻¹.
47. The porous metal fibre mat according to any of clauses 44 to 46, wherein the porous metal fibre mat has an average pore size ranging from 0.5 μm to 5.0 μm, optionally wherein the average pore size is about 2.5 μm.
48. The porous metal fibre mat according to any of clauses 44 to 47, wherein the porous metal fibre mat has a thickness ranging from 0.05 mm to 10 mm.
49. The porous metal fibre mat according to any of clauses 44 to 48, wherein the metal fibres in the metal fibre mat are nickel fibres, copper fibres, iron fibres, aluminium fibres, titanium fibres, or zinc fibres.
50. The porous metal fibre mat according to any of clauses 44 to 49, wherein the metal fibre mat is obtainable by the process according to of any of clauses 1 to 41.
51. Use of a porous metal fibre mat according to any of clauses 42 or 44 to 50, as an electrode.
52. The use according to clause 51, wherein the electrode is for use in a lithium-sulfur battery, a redox flow battery, a supercapacitor or a fuel cell.
53. Use of a porous metal fibre mat according to any of clauses 42 or 44 to 50, as a catalyst or a catalyst support.
54. Use of a porous metal fibre mat according to any of clauses 42 or 44 to 50, as a filtration material.

The present invention will now be described by way of reference to the following examples. These examples are not to be construed as being limiting on the invention.

### EXAMPLES

### Materials and Methods

The NiO powders were obtained from Fuel Cell Materials. The CuO powders, the PEO polymer and the DMF solvent were obtained from Sigma-Aldrich. The Zn powders were obtained from American Elements. The PAN polymer was obtained from Goodfellow. All materials were used without as provided and without purification unless otherwise stated.

The particles sizes were measured using SEM images. 10 mg of particles were first dispersed in 1 mL of ethanol by sonication, before dropping one drop of dispersion onto carbon tape. The carbon tape was put into a scanning electron microscope. The magnification was adjusted to show >20 particles in the view.

After saving the images, ImageJ is used to measure the diameters of 20 particles and calculate the average particles size.

### Example 1: Preparation of a ˜500 μm Nickel Mat Using Polyacrylonitrile (PAN)

0.8 g polyacrylonitrile (PAN, 230k g mol⁻¹) was dissolved in 10 mL of dimethylformamide (DMF) using a magnetic stirrer at 70° C. to form a transparent PAN/DMF solution. 5 g of NiO (500 nm particle size) was gradually added to the solution under magnetic stirring. The slurry was stirred at 70° C. for 4 h to evenly disperse NiO particles. After this, the slurry was transferred to a 10 ml syringe, before being loaded onto the electrospinning machine. In the electrospinning process, the nozzle was placed 15 cm from the roller collector; the temperature of slurry was kept at 50° C.; the syringe pumping rate was set to 1 mL h⁻¹; the voltage applied on the nozzle was adjusted between 7-20 KV to ensure a constant and stable extraction of fibres.

The NiO/PAN fibre mat was placed on a zirconia tray, and calcined in air to eliminate PAN and sinter NiO at 1000° C. for 5 h, with a 0.5° C. min⁻¹ ramping rate up to 600° C., which was then increased to 2° C. min⁻¹ to reach 1000° C. The resulting NiO mat is then cut to the size permitted in the tube furnace and calcined in the tube furnace in a 5% H₂/N₂ atmosphere to reduce the NiO mat to the final product, a 500 μm-thick Ni metal mat. The calcination was done at 800° C. for 5 h, with a ramping rate of 2° C. min⁻¹.

### Example 2: Preparation of a ˜2 mm Nickel Mat Using PAN

The preparation steps and raw materials are the same as used in example 1 until after electrospinning step, at which point two steps are added before calcination: the as-prepared NiO/PAN mat was folded 2 times; then it was pre-calcined in air at 250° C. for 2 h (ramped up at a rate of 1° C. min⁻¹) while pressed by two stainless steel plates with a total weight of ˜ 2 kg.

The pre-calcined mat then goes through the same calcination steps as described in example 1 to yield a 2 mm-thick Ni metal mat.

### Example 3: Preparation of a ˜300 μm Nickel Mat Using Polyethylene Oxide (PEO)

0.4 g polyethylene oxide (PEO, 100k g mol⁻¹) was dissolved in 10 mL water at 70° C. to form a transparent solution. Then 5 g of NiO (500 nm particle size) was gradually added to the solution under magnetic stirring. The slurry was electrospun under the same condition as described in example 1.

The as-spun NiO/PEO mat was cut and then calcined in the tube furnace in a 5% H₂/N₂ atmosphere to produce final Ni metal mat product. The calcination was carried out at 800° C. for 5 h, with a 0.5° C. min⁻¹ ramping rate up to 400° C. that was increased to 2° C. min⁻¹ to reach 800° C.

### Example 4: Preparation of a ˜500 μm Copper Mat Using PAN

The same slurry preparation and electrospinning steps described in example 1 were used, except for using CuO powder (800 nm particle size) instead of NiO (500 nm particle size).

The as-spun CuO/PAN mat was calcined in air at 750° C. for 5 h, with a 0.5° C. min⁻¹ ramping rate up to 600° C. that was increased to 2° C. min⁻¹ to reach 750° C. The CuO mat was then cut and calcined in the tube furnace in 5% H₂/N₂, at 650° C. for 5 h, with a ramping rate of 2° C. min⁻¹.

### Example 5: Preparation of a ˜500 μm Copper Mat Using PAN and a Surfactant

The same slurry preparation and electrospinning steps described in example 1 were used, except that 5 g CuO powder (200 nm particle size) was added to the PAN/DMF solution instead of NiO (500 nm particle size). 0.1 g Triton X-100 was added to the slurry as a surfactant to improve the particle dispersion and reduce the viscosity of the slurry.

The as-spun CuO/PAN was put through the same calcination steps as described in example 4 to produce a Cu mat.

### Example 6: Preparation of a ˜300 μm Zinc Mat Using PEO and Zinc Metal Powder

0.8 g polyethylene oxide (PEO, 60k g mol⁻¹) was dissolved in 10 mL DMF at 70° C. to form a transparent solution. Then 5 g of zinc (300 nm particle size) was gradually added to the solution under magnetic stirring. The slurry was then electrospun using the same condition as described in example 1.

The as-spun Zn/PEO mat was cut and then calcined in the tube furnace in 5% H₂/N₂ atmosphere to produce final Zn metal mat product. The calcination was done at 410° C. for 5 h, with 0.5° C. min⁻¹ ramping rate.

### Example 7: Comparing the Properties of a Nickel Fibre Mat and Nickel Foam

Tensile strength and compression tests were carried out on a nickel fibre mat as prepared in example 1 and a sample of nickel foam (Ni-5763 obtained from RECEMAT BV). The specific surface area, density, and porosity of the two materials are set out in the table below:

| | Volumetric | Gravimetric | | |
|---|---|---|---|---|
| | specific | specific | | |
| | surface area | surface area | Density | |
| | (m²/m³) | (m²/g) | (g/cm³) | Porosity |
| Ni fibre mat | 415000 | 1.2 | 0.36 | 96% |
| Commercial | 6900 | 0.02 | 0.36 | 96% |
| Ni foam | | | | |

The tensile and compression tests were performed on a Zwick/Roell universal testing platform.

In the tensile test, the 400 μm-thick sample was cut to rectangular shape of 1.5×4 cm², before loading on the machine. The equipment pulled on two ends of the sample with a rate of 2 mm min⁻¹ until it fractured. The tensile stress and strain were recorded.

In the compression test, the 400 μm-thick sample was cut to square shape of 2×2 cm² and then put on the machine. Then it was compressed by the equipment with a compression rate of 0.1 mm min⁻¹ until it reaches 90% strain. The compressive stress and strain were recorded.

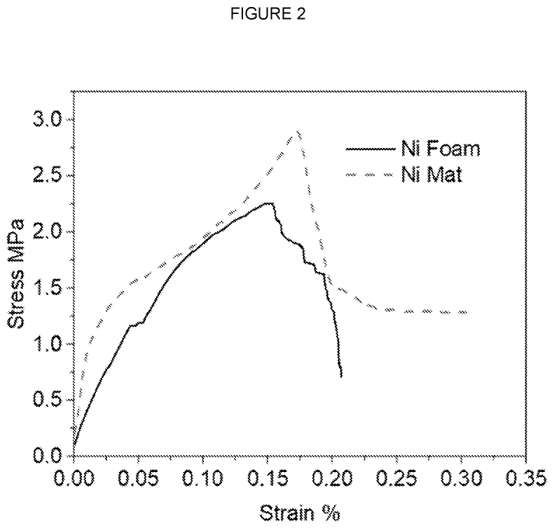

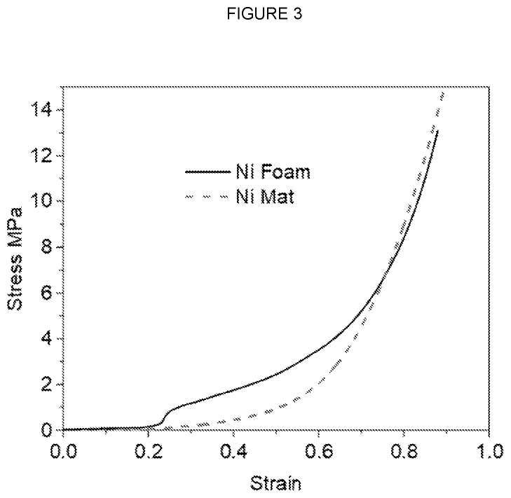

The tensile test results are shown in FIG. 2. Both Ni mat and Ni foam's curve show a linear behaviour at a low strain/stress region that is consistent with elastic deformation, in which the deformation of material is reversible after the load is withdrawn. The slope of this region is the Young's Modulus of the material. Ni mat has a steeper curve, suggesting it has a higher Young's Modulus and has a higher resistance to elastic deformation under tensile load.

After the linear region, both samples go through a shoulder, which is the yield point. After this point the deformation of the material is no longer reversible. The region after the yield point is non-linear. The maximum stress corresponds to the ultimate tensile strength (UTS), after which the material fractures. Ni mat has a higher UTS and better resistance against breaking than the Ni foam.

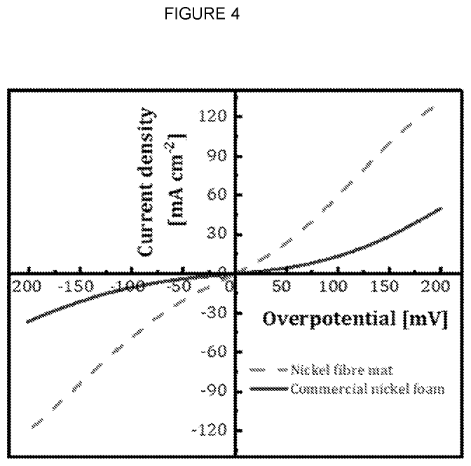

In the compression test in FIG. 4, the Ni foam shows a shoulder at 0.23% strain, while the Ni mat doesn't show this feature. This feature is the transition point of elastic deformation to plastic deformation, after which the deformation is irreversible. This suggests that the Ni mat has a lower resistance to elastic deformation under compressive load than the Ni foam, and that most of its deformation under compression is not reversible.

### Example 8-Observing the Electrochemical Properties of a Nickel Fibre Mat and Nickel Foam

Tests were carried out using the same kind of nickel fibre mat and nickel foam used in example 7, except that the thickness of the matt/foam was varied as indicated below. Before electrochemical test, the samples were sulfidised by boiling in 1 M Na₂S₂+1 M NaOH solution for 1 h, which converted the surface nickel to nickel sulfides. The sulfidised nickel mat was tested in two electrochemical applications:

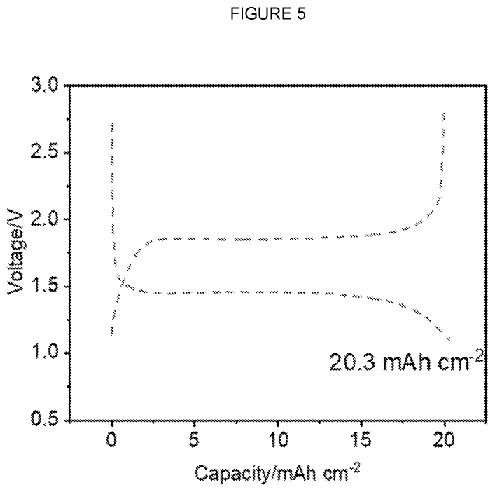

The first test was as the electrochemical catalyst of polysulfide oxidation/reduction reaction: A 1.5 mm sulfidised nickel fibre mat was placed as the working electrode of a three-electrode cell, with platinum wire as the counter electrode and Ag/AgCl reference electrode. The nickel fibre mat was tested by linear scan voltammetry (LSV) in 1 M Na₂S₂+1 M NaOH solution. The nickel fibre mat showed 4-5 times higher activity comparing with 2 mm nickel foam tested under the same condition (as shown in FIG. 5).

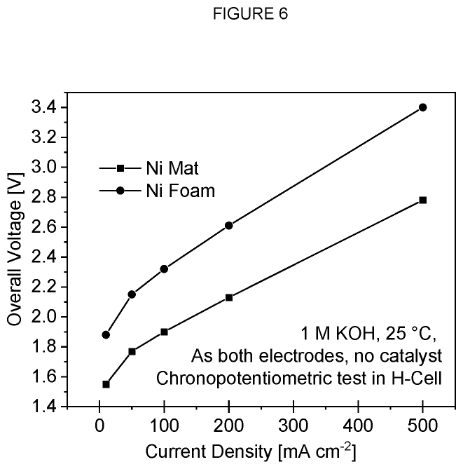

The second test was as the cathode of a lithium ion battery: A 500 μm sulfidised nickel fibre mat was assembled into a standard CR2032 coin cell as the cathode, with lithium chips as the anode. The coin cells were cycled between 1.2 and 2.7 V under 2 mA cm⁻² current density and exhibited >20 mAh cm⁻² of areal capacities (as shown in FIG. 6). This compares favourably with the areal capacities of commercial lithium ion batteries, which are usually lower than 5 mAh cm⁻².

### Example 9: Preparation of an Aluminium Mat Using Polyethylene Oxide (PEO) and a Sintering Aid

0.7 g polyethylene oxide (PEO, 60k g mol⁻¹) was dissolved in 10 mL of dimethylformamide (DMF) at 70° C. to form a transparent PEO/DMF solution. 2 g of aluminium (300-500 nm particle size), 0.3 g KAlF₄ was gradually added to the solution under magnetic stirring. The slurry was then electrospun using the same conditions as described in Example 1.

The as-spun composite mat was cut and then calcined in the tube furnace in 5% H₂/N₂ atmosphere to produce the final aluminium fibre metal mat product. The KAlF₄ decomposed during the process. The calcination was done at 600° C. for 5 h, with 0.5° C. min⁻¹ ramping rate.

### Example 10: Preparation of an Aluminium/Magnesium Mat Using Polyethylene Oxide (PEO) and Sintering Aids

0.7 g polyethylene oxide (PEO, 60k g mol⁻¹) was dissolved in 10 mL dimethylformamide (DMF) at 70° C. to form a transparent solution. 2 g of aluminium (300 nm particle size), 0.1 g of magnesium, 0.2 g of KAlF₄ was gradually added to the solution under magnetic stirring. The slurry was then electrospun using the same condition as described in Example 1.

The as-spun composite mat was cut and then calcined in the tube furnace in 5% H₂/N₂ atmosphere to produce the final Al/Mg alloy fibre metal mat product. The KAlF₄ decomposed during the process. The calcination was done at 600° C. for 5 h, with 0.5° C. min⁻¹ ramping rate.

### Example 11-Observing the Electrochemical Properties of a Nickel Fibre Mats and Nickel Foams as Both Electrodes of Alkaline Water Electrolyser

Tests were carried out using the same kind of nickel fibre mat and nickel foam used in example 7. The testing was performed with a H-Cell, containing 100 mL of 1M KOH aqueous solution. Nickel fibre mats or nickel foams were used as both cathodes (hydrogen electrode) and anodes (oxygen electrode) of the electrolyser.

Current densities of 10, 50, 100, 200 and 500 mA cm⁻² were applied through the electrodes for 5 minutes respectively. The average voltages were recorded and shown in FIG. 6. No catalyst was coated on the tested nickel fibre mats or nickel foams. The results are shown in FIG. 6, wherein it can be seen that nickel fibre mats prepared according to the invention provided lower voltages when compared with nickel foams. Lower voltage is an indication of better performance.

1. A process for preparing a porous metal fibre mat comprising:
a. providing a slurry comprising particles selected from metal particles, metal compound particles, or combinations thereof, and a polymer carrier in a solvent;
b. electrospinning the slurry to fabricate a composite fibre mat; and
c. heating the composite fibre mat to produce a porous metal fibre mat.

2. The process according to claim 1, wherein the particles are metal particles selected from nickel particles, copper particles, iron particles, aluminium particles, titanium particles, zinc particles, or a mixture thereof.

3. The process according to claim 1, wherein the particles are metal compound particles selected from nickel oxide particles, copper oxide particles, iron oxide particles, aluminium oxide particles, titanium oxide particles, zinc oxide particles, or a mixture thereof.

4. The process according to claim 1, wherein the particles have an average size of from 0.01 μm to 2 μm.

5. The process according to claim 1, wherein the particle loading in the slurry ranges from 0.2 g mL⁻¹ to 0.9 g mL 1.

6. The process according to claim 1, wherein the polymer carrier is a polyacrylonitrile (PAN), a polyethylene oxide (PEO), a polyvinylpyrrolidone (PVP), a polyvinyl alcohol (PVA), a polyamide (Nylon), a polymethylmethacrylate (PMMA), a polyvinyl ether (PVE), a polyethylene terephthalate (PET), a polyvinylidene fluoride (PVDF), a polyvinyl chloride (PVC), a chitosan, a lignin, a cellulose, or a polylactic acid (PLA).

7. The process according to claim 1, wherein the polymer carrier is selected from:
PAN with a weight average molecular weight of from 50k to 400k g mol-1;
PEO with a weight average molecular weight of from 15k to 500k g mol 1; or
PVP with a weight average molecular weight of from 50k to 1300k g mol-1.

8. The process according to claim 1, wherein the polymer carrier is selected from:
PAN with a molecular weight of from 200k to 260k g mol-1 provided in the slurry in an amount of from 0.05 to 0.15 g mL-1, optionally wherein the PAN has a molecular weight of about 230k g mol-1;
PEO with a molecular weight of from 15k to 60k g mol-1 provided in the slurry in an amount of from 0.08 to 0.20 g mL 1, optionally wherein the PEO has a molecular weight of about 30k g mol-1;
PEO with a molecular weight of from 30k to 90k g mol-1 provided in the slurry in an amount of from 0.04 to 0.15 g mL 1, optionally wherein the PEO has a molecular weight of about 60k g mol-1; or
PEO with a molecular weight of from 70k to 130k g mol-1 provided in the slurry in an amount of from 0.02 to 0.08 g mL 1, optionally wherein the PEO has a molecular weight of about 100k g mol-1.

9. The process according to claim 1, wherein the solvent is selected from water, dimethylformamide (DMF), ethanol, acetone, acetic acid, formic acid, chloroform, dichloromethane (DCM), dimethyl sulfoxide (DMSO), dimethylacetamide (DMA), toluene, oxolane, or a mixture thereof.

10. The process according to claim 1, wherein the slurry further comprises a surfactant, optionally wherein the surfactant is present at a concentration ranging from 0.001 g mL-1 to 0.05 g mL-1.

11. The process according to claim 1, wherein the composite fibre mat is heated to a temperature of from 200° C. to 2000° C. during the heating step.

12. The process according to claim 1, wherein the temperature is increased at a rate of from 0.2° C. min-1 to 2° C. min-1 during the heating step.

13. The process according to claim 1, wherein the composite fibre mat is contacted with a H2 gas during the heating step, optionally wherein the H2 gas comprises at least 5 vol % H2.

14. The process according to claim 1, wherein the heating step is comprises a first stage for removing the polymer carrier in the composite fibre mat and sintering the particles, and a second stage for reducing any metal compound particles to yield the porous metal fibre mat.

15. The process according to claim 1, wherein prior to the heating step, the composite mat is either folded onto itself or multiple composite fibre mats prepared in accordance with the process are laid on top of each other, optionally wherein the folded or overlaid composite fibre mat is subjected to a pre-heating step prior to the heating and reducing steps.

16. (canceled)

17. A porous metal fibre mat, having:
a specific surface area of at least 500 cm-1; and
a thickness of at least 0.05 mm.

18. The porous metal fibre mat according to claim 17, wherein;
(a) the porous metal fibre mat has a porosity of at least 50 vol %, for example from 80 vol % to 98 vol %, or for example from 80 vol % to 90 vol %; or
(b) the porous metal fibre mat has a specific surface area of from 500 cm-1 to 50000 cm-1; or
(c) the porous metal fibre mat has an average pore size ranging from 0.5 μm to 5.0 μm, optionally wherein the average pore size is about 2.5 μm; or
(d) the porous metal fibre mat has a thickness ranging from 0.05 mm to 10 mm; or
(e) the metal fibres in the metal fibre mat are nickel fibres, copper fibres, iron fibres, aluminium fibres, titanium fibres, or zinc fibres.

19-23. (canceled)

24. An electrode, comprising the porous metal fibre mat according to claim 17, optionally in a lithium-sulfur battery, a redox flow battery, a supercapacitor or a fuel cell.

25. A catalyst or a catalyst support, or a filtration material comprising the porous metal fibre mat according to claim 17.

26. The process according to claim 1, wherein the porous metal fibre mat has:
a specific surface area of at least 500 cm-1; and
a thickness of at least 0.05 mm.
